(19) United States
(12) Patent Application Publication
(10) Pub. No.: US 2005/0027636 A1
(43) Pub. Date: Feb. 3, 2005

(54) Method and apparatus for trading energy commitments

(76) Inventors: Joel Gilbert, Tucker, GA (US); William M. Smith, Oakland, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/629,891

(22) Filed: Jul. 29, 2003

(51) Int. Cl. G06F 17/60

(52) U.S. Cl. 705/37

(57) ABSTRACT

The present invention comprises a method, and corresponding system, apparatus and memory for trading energy commitments to reduce or increase energy demand (a demand response commitment), to increase or reduce energy production (a supply response commitment) upon demand or to deliver or to not deliver energy (an energy delivery commitment). Such commitments are made available by energy consumers, energy generators and energy delivery companies, respectively, to an entity that provides consideration for these energy commitments and trades them as fungible commodities to energy market participants. In one embodiment, the present invention comprises a method for trading energy commitments to reduce or increase energy consumption, to increase or reduce energy generation, or to deliver energy, comprising receiving a plurality of multi-year energy commitments; providing consideration for each of the multi-year energy commitments; and trading at least one of the plurality of energy commitments upon demand.

### BACKGROUND OF THE INVENTION

1. Field of Invention

The invention relates generally to transactions in the energy market. More specifically, the invention is directed to a method, system and apparatus for trading energy commitments, wherein such energy commitments comprise commitments to reduce or increase energy demand upon demand, to increase or reduce energy production upon demand or to deliver energy upon demand.

2. Description of Related Art

Electricity generation and distribution has historically been a government-regulated business. Under these regulations, power suppliers or utility companies would be required to seek approval from a regulatory body, such as a Public Utility Commission (PUC), to include various costs in their electricity rate base, which is basically the price charged to consumers for electricity. For example, if a power supplier needed increased generating capacity to meet a forecast for increased demand, the power supplier could decide to build a new power plant. Before building this new generating capacity, however, the power supplier would first seek approval from the PUC before the plant would be built to make sure that the costs of building the new plant could be included in the rate base. That way, the power supplier was assured that it could recover those costs, thereby economically justifying the construction of a new plant.

With deregulation, however, the power market has behaved erratically due to the lost assurance of cost recovery provided by the regulatory business environment. Normally, increased demand for power would be expected theoretically to result in an increase of power generating capacity. Instead, such increased demands for power often occur in swings from high demand to low demands, which can be of significant magnitude, for example, when air conditioning demands increase in response to a particularly high temperature summer season. Such swings are also unpredictable and may not repeat themselves, such as when the next summer season does not have the same significantly high temperatures. As a result, the power supply market has experienced boom and bust cycles with respect to expectations regarding rates of return on investments in the market, including, for example, investments in generation or transmission/distribution equipment, which hinders further investments. Either the demand increases and, without sufficient generating capacity, the price of electricity increases significantly or the supply market has excess power available in lower demand periods that significantly reduces the return on investment for that excess power generating capacity. Therefore, the power supply market and investments therein do not appear to be sufficiently responsive to economic signals from the demand side of the market.

To add stability to the market, demand-response programs have been undertaken by utilities. These programs are designed to influence customer demands for energy in order to optimize the use of available generating capacity and to potentially defer investment in new generating capacity. Some programs provide incentives to power consumers to change their electricity usage. For example, consumers may pay less for electricity that is used during off-peak times or those periods when the overall or aggregate demand for power is lower, such as in the late evening. Other programs provide incentive to power consumers to use more energy efficient appliances and equipment, such as energy efficient water heaters and air conditioners. However, such programs have not been widely adopted and have not provided the expected stability to the power market. Therefore, there is a need for a method of trading that adequately impacts the energy market to provide incentive for investments in new generating capacity, transmission and distribution equipment and efficiency of energy use and to, thereby, minimize or avoid the boom/bust cycles experienced by the present energy market.

### SUMMARY OF THE INVENTION

The present invention comprises a method, and corresponding system and apparatus, for trading energy commitments to reduce or increase energy demand (a demand response commitment), to increase or reduce energy production (a supply response commitment) upon demand, or to deliver or to not deliver energy (an energy delivery commitment). Basically, such commitments are made available by energy consumers, energy generators, and energy delivery companies, respectively. These commitments are offered to an entity, referred to herein as a bank, that will essentially trade these commitments as fungible commodities. In exchange for these commitments, the bank will provide consideration to the entities making these commitments. The bank can secure multiple commitments each having various levels of commitment to reduce or increase energy demand or to increase or reduce energy generation, thereby building a “reserve” of commitments, similar to the Federal Reserve Bank, which has a reserve of cash for the “money circulation market,” or the national strategic oil reserves, which would be used to address dramatic changes in the oil market. Preferably, the bank is a regional bank that serves a particular or predetermined geographic area. The bank could then offer to trade these commitments, or some aggregate, subset or combination thereof, to energy market participants that buy and sell power. These energy market participants would then buy these commitments, aggregate, subset or combination thereof from the bank and determine whether to exercise the commitment by demanding that the entity that made the commitment comply by either reducing or increasing energy demand or production or delivery of energy, as the case may be.

In one embodiment, the present invention comprises a method for trading energy commitments to reduce or increase energy consumption or to increase or reduce energy generation, comprising: receiving, solely for trading, a plurality of multi-year energy commitments upon demand; providing consideration for each of the multi-year energy commitments; and trading at least one of the plurality of energy commitments upon demand.

In another embodiment, the present invention comprises a method for trading energy commitments to reduce or increase energy consumption or to increase or reduce energy generation, comprising receiving a plurality of multi-year energy commitments to reduce or increase energy consumption or to increase or reduce energy generation by a predetermined quantity upon demand; providing consideration for each of the multi-year energy commitments; combining at least a portion of at least two of the multi-year energy commitments to form a product; trading said product upon request.

In another embodiment of the present invention, the energy commitment comprises a commitment to deliver or to not deliver energy (i.e., an energy delivery commitment). Such an energy delivery commitment could be made by a company that delivers energy, such as a transmission/distribution company or a grid operator.

Further according to the invention there is provided a system for trading energy commitments to reduce or increase energy consumption, to increase or reduce energy generation, or to deliver energy. The system includes a bank, one or more energy consumers, energy generators, aggregators, third party appraisers, and/or energy market participants. The bank includes a processor, communications circuitry, and a memory. The communications circuitry is for communicating with the one or more energy consumers, energy generators, aggregators, third party appraisers, and/or energy market participants. The memory includes an operating system, communication procedures and energy commitment trading procedures. The communication procedures are for receiving, solely for trading, a plurality of multi-year energy commitments, and providing consideration for each of said multi-year energy commitments. The trading procedures are for trading at least one of said plurality of energy commitments upon demand.

Still further, according to the invention there is provided a computer program product for trading energy commitments to reduce or increase energy consumption, to increase or reduce energy generation, or to deliver energy. The computer program product includes a computer readable storage and a computer program stored therein. The computer program includes: instructions for receiving, solely for trading, a plurality of multi-year energy commitments; instructions for providing consideration for each of said multi-year energy commitments; and instructions for trading at least one of said plurality of energy commitments upon demand.

The making and depositing of these energy commitments and subsequent trading of these energy commitments provides energy market participants, such as electricity suppliers, with valuable resources that can be used to respond to changes in the overall electricity demand market. In addition, a market that trades in demand response commitments would encourage power consumers to invest in, for example, the development of technologies that allow them to make such demand response commitments, such as investment in more energy efficient equipment. Similarly, a market that trades in supply response commitments would encourage energy generators to invest in, for example, additional power generating capacity and would encourage energy consumers to invest in, for example, distributed generation, wherein an energy user generates energy for its own consumption as well as excess energy that is returned to the grid. Similarly, a market that trades in energy delivery commitments would encourage investments by transmission/distribution companies in, for example, their respective equipment. Such investments by energy consumers and generators and transmission/distribution companies, and the availability as a fungible commodity of commitments to reduce or increase energy demand, to increase or reduce energy generation or to deliver energy would act to avoid or at least reduce the wild swings and boom/bust cycles in the energy market.

Other features and benefits of the invention will appear from the following description from which the preferred embodiments are set forth in detail in conjunction with the accompanying drawings.

### BRIEF DESCRIPTION OF THE DRAWINGS

FIG. 1 is a block diagram of a system for trading energy according to an embodiment of the invention;

FIG. 2 is block diagram of a preferred embodiment of the bank shown in FIG. 1; and

FIGS. 3A and 3B are flow charts of a method for depositing and trading energy commitments, according to an embodiment of the invention.

Like reference numerals refer to the same corresponding parts throughout the several views of the drawings.

### DETAILED DESCRIPTION OF THE PREFERRED EMBODIMENTS

In general, the present invention comprises a method, and corresponding system and apparatus, for trading energy commitments. Such energy commitments comprise any commitment related to generation, transmission/distribution or consumption of energy. For example, energy commitments includes commitments to either reduce energy demand (referred to as a demand response commitment) or to increase or reduce energy generation (referred to as a supply response commitment) upon demand or upon request by a subsequent holder of the commitment. For example, an energy consumer may make a contractual commitment to reduce or increase energy demand or use by a certain amount for a certain period of time upon demand by the recipient or holder of this contractual commitment. Similarly, an energy generator may make a contractual commitment to increase or reduce energy generation by a certain amount for a certain period of time upon demand by the recipient or holder of the contractual commitment. In addition, energy commitments includes commitments to deliver, or to not deliver, energy (referred to as an energy delivery commitment), which may be made by an entity that transmits or distributes energy, including, for example, a transmission/distribution company or a grid operator.

It should be appreciated that while such energy commitments would typically be defined by an amount of energy for a given or certain period of time, such energy commitment may also be defined as simply an amount of power, irrespective of a particular time period or may include commitments for both energy and power. Therefore, the use of the term “energy” in “energy commitment” should not be construed as being limited to those commitments defined or specified using the technical definition for energy as opposed to the technical definition of power.

These energy commitments are received by an entity, referred to herein as a “bank,” that subsequently trades these commitments to other parties. In other words, the bank receives these energy commitments strictly for the purpose of trading them, similar to an individual's purchase of stock or options. The bank receives these energy commitments, provides consideration to the entity making the commitment, and can then either sell them or hold them until a later point in time when their value has appreciated, at which point the bank would sell them. Of course, some of these energy commitments may lose their value over time, such that the bank cannot sell them. In this case, these energy commitments would be valueless.

In essence, the bank acts as a trader of a fungible commodity, i.e., the demand response commitment, the supply response commitment or the energy delivery commitment. These energy commitments are fungible commodities since the bank acts to make these energy commitments freely available to the marketplace. It should be appreciated that the bank may group energy commitments and/or any portion, including the entire portion, of any energy commitments for trading. The bank can trade these energy commitments to any entity desirous of purchasing such commitments, such as energy market participants as described below, including energy generators, energy consumers and energy distribution/transmission companies.

In theory, the bank makes a profit by purchasing and subsequently selling multiple energy commitments that in the aggregate have various amounts of, for example, reduced or increased energy demand, increased or reduced energy supply or energy delivery availability for various durations over various periods of time, such as hours, days, weeks, months, years or seasons. By purchasing such multiple energy commitments, the bank can aggregate, in theory, a plurality of energy commitments that, in toto, provides a large total amount of, for example, reduced or increased energy demand, increased or reduced energy supply or energy delivery availability covering all periods of time. Having such a base of energy commitments can minimize the financial risk associated with such purchases, since, most likely, some energy commitments will become more valuable and others may decrease in value over time. Of course, the value of energy commitments to, for example, reduce or increase energy demand, increase or reduce energy supply or energy delivery availability will depend upon a plethora of factors, such as weather or seasonal climatic conditions and reserve generating capacity in the region, among others.

As a simple example with respect to a demand response commitment, multiple energy consumers (or an aggregator that aggregates a number of energy consumers' commitments and acts on behalf of these consumers) may make certain commitments to reduce energy demand by various amounts and at various periods of time. Such demand response commitments are essentially transferable and assignable contracts. The bank when trading in demand response commitments may also be referred to as a demand response resource bank that receives these commitments for immediate or later trading and provides consideration to each of the energy consumers. It should be appreciated that this consideration may take any form. For example, this consideration may be a fixed monetary payment or comprise monthly levelized payments for a given number of years. The form and amount of consideration provided would depend upon the details of each commitment, such as the magnitude of the reduction in energy use agreed upon, the duration over which such reduction would occur, the periodic nature of such a reduction (for example, whether the reduction would be made every day, week, year or season), if any, and the ability or probability of the energy consumer to actually make such a reduction in its energy use at the specified time.

An energy generator or other energy market participant as described below (e.g., ISO, utility distribution company that offers bundled electric service, vertically integrated utilities in regulated markets, etc.) who then anticipates an inability to meet an increase in energy consumption may purchase any one, any portion of any one, or a combination of any or any portion of these demand response commitments from the bank at any time when needed. Upon actually realizing the inability to meet an increase in energy demand, the energy generator may call upon the energy consumers who made the commitments (or the bank, which would in turn call upon the energy consumers) to actually reduce their energy demand or use as agreed upon in their commitment. In one embodiment, such trading of commitments by the bank is limited to a specific geographic region to better reflect the market conditions relating to energy demand in that region and to reflect the transmission constraints between, for example, the NERC regions in the United States. In this case, there would be multiple regional banks to cover, for example, the entire United States.

As a simple example with respect to a supply response commitment, multiple energy generators (or an aggregator) may make certain commitments to increase energy supply by various amounts and at various periods of time. Such supply response commitments are essentially transferable and assignable contracts. The bank when trading in supply response commitments may in this case be referred to as a supply response resource bank that receives these commitments for immediate or later trading and provides consideration to each of the energy generators. It should be appreciated that this consideration may take any form. For example, this consideration may be a fixed monetary payment or comprise monthly levelized payments for a given number of years. The form and amount of consideration provided would depend upon the details of each commitment, such as the magnitude of the increase in energy supply agreed upon, the duration over which such increase would occur, the periodic nature of such an increase (for example, whether the increase would be made every day, week, year or season), if any, and the ability of the energy generator to actually make such an increase in its energy production at the specified time.

A energy consumer or other energy market participant as described below (e.g., ISO, utility distribution company that offers bundled electric service, vertically integrated utilities in regulated markets, etc.) who anticipates an increased need for energy may purchase any one, any portion of any one, or a combination of any or any portion of these supply response commitments. Upon actually realizing the need for additional energy, the energy consumer may call upon the energy generators (or the bank, which would in turn call upon the energy generators) who made the commitments to actually increase their energy supply as agreed upon in their commitment. In one embodiment, such trading of supply response commitments by the bank is limited to a specific geographic region to better reflect the market conditions relating to energy demand in that region and to reflect the transmission constraints between, for example, the NERC regions in the United States. In this case, there would be multiple regional banks to cover, for example, the entire United States.

It should be appreciated that energy delivery commitments would be made and traded in a manner similar to the examples described above. Such energy delivery commitments could be made by transmission/distribution companies or grid operators and traded by the bank to any energy market participant.

Specific embodiments of the invention are described below in connection with the Figures. The same Figures are used to illustrate trading in both demand response commitments as well as supply response commitments. To reflect this, the Figures refer to both energy consumers and generators as “consumer/generator” or as “generator/consumer” depending upon whether a demand response commitment or a supply response commitment is being traded. It should also be appreciated that the term “trade” or “trading” is intended to be generic and includes all types of exchanges for consideration, including the specific buying and selling of energy commitments according to the present invention. It should also be appreciated that the term “energy” as used herein includes all forms energy and energy sources, such as electricity, natural gas, nuclear, water, oil, wind, solar or the like. However, for ease of explanation, much of the description below will refer to electricity. It should be appreciated that such embodiments are not intended to limit the scope of the invention. It should also be appreciated that while the following discussion is limited to demand response and supply response commitments, that energy delivery commitments would be made and traded in a similar manner. As such, an entity that transmits or delivers energy would take the place of the “consumer/generator” or “generator/consumer” in the Figures, while the energy market participants would remain the same and would include entities that make energy delivery commitments, such as transmission and distribution companies.

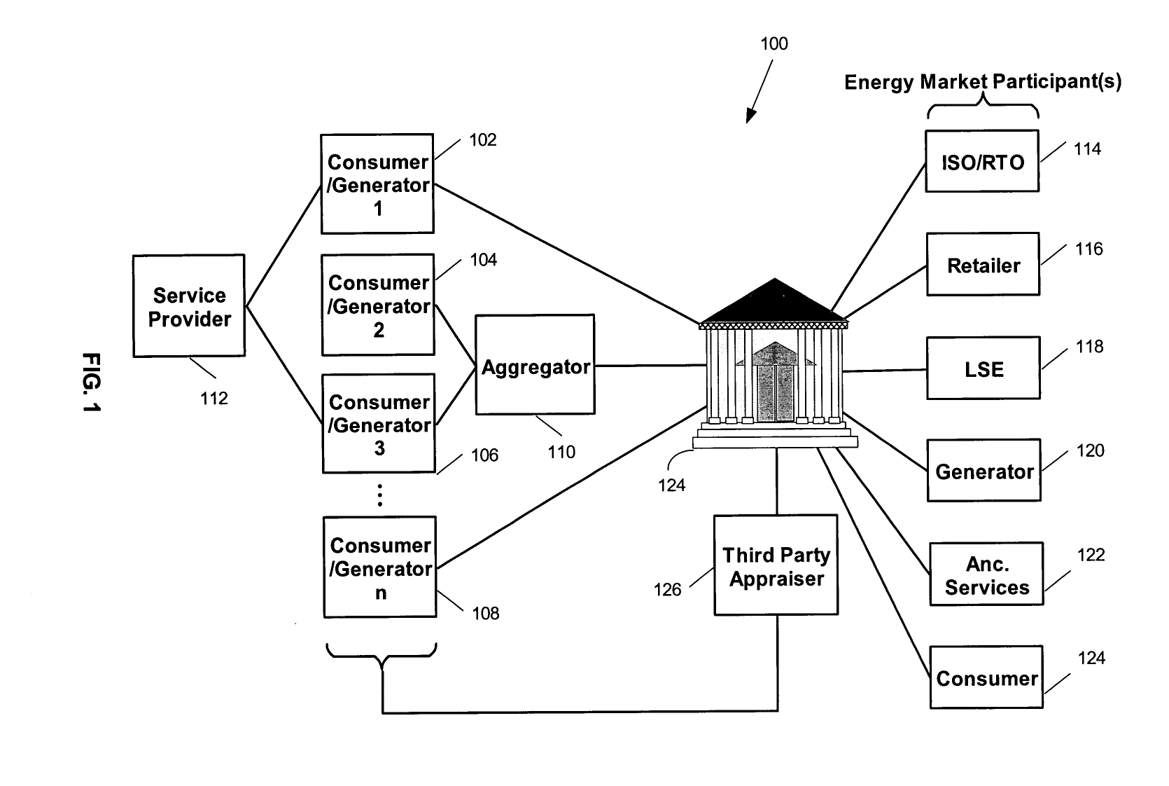

FIG. 1 is a block diagram of a system 100 for trading energy commitments, including both demand response commitments and supply response commitments. As such, the system 100 includes both multiple energy consumers 102-108 that make demand response commitments and multiple energy suppliers 102-108 that make supply response commitments. Again, it should be appreciated that while FIG. 1 illustrates one embodiment of the present invention in terms of demand and supply response commitments, it is equally applicable to energy delivery commitments, wherein the energy consumer or generator would be instead an entity that delivers energy, such as a transmission/distribution company or a grid operator and references specifically to demand/supply response commitments would refer instead to energy delivery commitments.

The energy consumers 102-108 include any entity that uses energy, including, for example, residential, commercial, industrial and agricultural electricity users. The energy consumers 102-108 have the ability to both consume energy as well as reduce or eliminate energy consumption. For example, an energy consumer may agree to consume “x” megawatt-hours of electricity a year or conversely agree to reduce energy consumption by “y” megawatt-hours for a certain period of time when called upon to do so. Accordingly, the energy consumers 102-108 make demand response commitments, i.e., a promise to reduce or eliminate energy consumption or demand or to increase their energy consumption or demand when called upon to do so. It should be appreciated that each demand response commitment may be significantly different. For example, one energy consumer may agree to reduce its energy demand by a given amount for a given duration each day, week, month, year or season, while another may agree to increase its power consumption generally. Such commitments are preferably multi-year commitments spanning a predetermined number of years. Further, the conditions under which such commitments may be exercised may vary as well. For example, one could envision that a given energy consumer may require a certain amount of notice before having to actually reduce its energy consumption.

Similarly, the energy generators 102-108 include entities that generate energy. For example, an energy generator may generate “x” megawatt-hours of electricity a year or conversely agree to generate “y” additional megawatt-hours for a certain time period when called upon to do so. Accordingly, the energy generators 102-108 make supply response commitments, i.e., a promise to increase or reduce its energy generation for a certain period of time when called upon to do so. It should be appreciated that each supply response commitment may be significantly different. For example, one energy generator may agree to generate a given amount of energy for a given duration each day, week, month, year or season, while another may agree to increase its power generation generally. Such commitments are preferably multi-year commitments spanning a predetermined number of years. Further, the conditions under which such commitments may be exercised may vary as well. For example, one could envision that a given energy generator may require a certain amount of notice before having to actually generating additional energy.

The system 100 also includes energy market participants, which includes any entity desirous of purchasing energy commitments and which may include entities that also make energy commitments. Other energy market providers include, for example, Regional Transmission Organization(s) (RTO) or Independent System Operator(s) (ISO) 114, energy retailer(s) 116, load serving entities (LSE) 118, energy generator(s) 120, ancillary services 122 and energy consumer(s) 124. An RTO controls, operates and may independently own the energy transmission facilities. RTOs are being established in the United States to operate the high-voltage interstate transmission system or grid in a reliable, non-discriminatory manner and to coordinate with other critical entities, such as participating utilities and generators, neighboring RTOs and power exchanges. ISOs are entities designed operate the transmission system in a safe, reliable manner and to encourage open and non-discriminatory grid access. An ISO is one form of a Regional Transmission Organization. The ISO controls and operates the transmission systems of regional utilities so that energy generators can transmit power over the transmission lines. Actual ownership of the transmission and distribution facilities remains with the individual utilities or other independent transmission providers (ITPs), which continue to collect revenues and pay expenses related to the transmission assets. The energy retailer(s) 116 sell energy directly to the end user or energy consumer 102-108. The LSEs are utilities, marketers, or aggregators, including energy retailers, who provide electric energy to a large number energy consumers 102-108. Ancillary services 122 include other requirements to assure satisfactory and reliable provision of electric service, e.g., voltage support, short-term energy generation reserves, etc. These requirements can be provided by one or more of the energy market participants described above.

The system 100 also includes an entity that trades in energy commitments such as an exchange or bank 124. The bank 124 purchases energy commitments from energy consumers 102-108 or energy generators 102-108 for the specific purpose of trading or resale and acts as a centralized exchange for such trading. The bank 124 is preferably regional, i.e., a single bank 124 that exists for certain geographic regions, such as the ten NERC regions in the United States. It should, however, be appreciated that there may be several regions within a geographic area, several regions throughout the world, or a single region.

As described above, the bank's main purpose is to purchase energy commitments from the energy consumers 102-108 and/or energy generators within its region for resale, store these energy commitments for immediate or later resale and then trade in these energy commitments. In other words, the energy consumers/generators 102-108 can deposit their existing demand/supply response capabilities in the bank 124 in exchange for some form of consideration. It should be appreciated that this consideration may take any form. For example, this consideration may be a fixed monetary payment or may comprise monthly levelized payments for a given number of years. The form and amount of consideration provided would depend upon the details of each energy commitment, such as the magnitude of the energy being committed, the duration of the commitment, the periodic nature of the commitment (for example, whether the reduction in energy or increase in generation would be made every day, week, year or season), if any, and the ability of the energy consumer/generator to actually perform the commitment at the specified time. Alternatively, or in addition to, the consideration paid by the bank 124 to the energy consumers/generators 102-108 making energy commitments, the bank 124 may lend money to the energy consumers/generators 102-108, or their agents, to invest in additional technology, equipment or services to enable the energy consumer/generator to make additional energy commitments. Typically, the bank 124 generally sells the energy commitments to the energy market participants 114-122.

It should be appreciated that the bank 124 will receive multiple energy commitments from multiple sources. While the bank 124 may subsequently trade in single energy commitments, the bank 124 may also aggregate two or more of these energy commitments to make a product to be traded or sold to an energy market participant, as described below. Products may also be formed by combining portions or subsets of energy commitments rather than aggregating entire energy commitments, although such portions of some energy commitments may include the entire energy commitment. For example, each product may contain both demand and/or supply response commitments and/or portions thereof. For example, one product may include a number of demand response commitments for different geographic areas within a particular region, different periods for reduction of energy consumption, different amounts of energy required to be reduced, etc. Similarly, another product may include a number of supply response commitments for different geographic areas within a particular region, different periods for increased energy generation, different amounts of energy required to be generated, etc. It should be appreciated that the bank 124 may form such products at its own discretion for subsequent trade or sale or form such products at the request of an energy market participant in need of a tailored product covering various energy demand and generation needs.

The system 100 may also include one or more aggregators 110. The aggregators 110 combine or aggregate energy commitments from energy consumers/generators 104-106 for sale to the bank 124. Aggregators are useful for less financially sophisticated energy consumers/generators who do not have the will or ability to sell their energy commitments directly to the bank 124.

Further, the system 100 may also include one or more service providers 112. The service providers 112 preferably assists energy consumers 102, 106 with developing the technical capability required to make an energy commitment. For example, a service provider 112 may invest in an energy consumer to install energy efficient equipment at an energy consumer's facility that allows that energy consumer to commit to a reduction in energy demand. Alternatively, a service provider 112 may invest in an energy generator to install additional generating capacity.

Still further, the system 100 may preferably include one or more third party appraisers 126. In a preferred embodiment, before the bank 124 purchases energy commitments from the energy consumers/generators 102-108, the bank 124 arranges for an independent valuation by a third party appraiser 126 of the consumers'/generators' ability to meet their respective energy commitment. The third party appraiser 126 would then perform a valuation of the consumers'/generators' capabilities based on, for example, a set of predetermined guidelines to determine the viability of a given energy commitment. For example, the valuation verifies the energy consumers'/generators' technical ability to comply with a request to reduce energy demand or increase energy generation, respectively, when called upon to do so. Additionally, the third party appraiser 126 may evaluate the financial viability of a given energy commitment based upon existing energy commitments already held by the bank 124. Once the resources are proven deposits in the bank, the energy commitments can be made available for trading to the energy market participants. This allows the bank to assure all energy market participants that the energy commitments are not being sold beyond their proven capabilities. Of course, the energy market participants may also conduct their own valuation of the viability of the energy commitments that are being purchased from the bank. Such valuations may be performed updated throughout the life or term of the energy commitment to assure the sustained availability of the actual energy demand/supply response.

In a preferred embodiment, the system 100 is a network of interconnected computing devices. Accordingly, the energy consumers/generators 102-108, aggregator(s) 110, bank 124, energy market participants 114-122, third party appraiser 126 and service provider 112 are all interconnected computing devices. In a preferred embodiment, these computing devices communicate with one another over a wide area network (WAN), such as the Internet. Also in a preferred embodiment, the interconnected computing devices of the energy consumers/generators and energy market participants are standard computers, such as laptop or desktop computers, running a Web browser, including INTERNET EXPLORER or NETSCAPE. In this embodiment, no special software is required to communicate with the bank 124 other than the Web browser. The Web browsers on the computing devices preferably communicate with the bank over a secure connection, such as a Secure Sockets Layer (SSL). It should, however, be appreciated that the system 100 may include one or more private networks, and the various computing devices may run one or more specialized applications. In addition, it should be appreciated that parts or all of the system 100 may not be computer implemented.

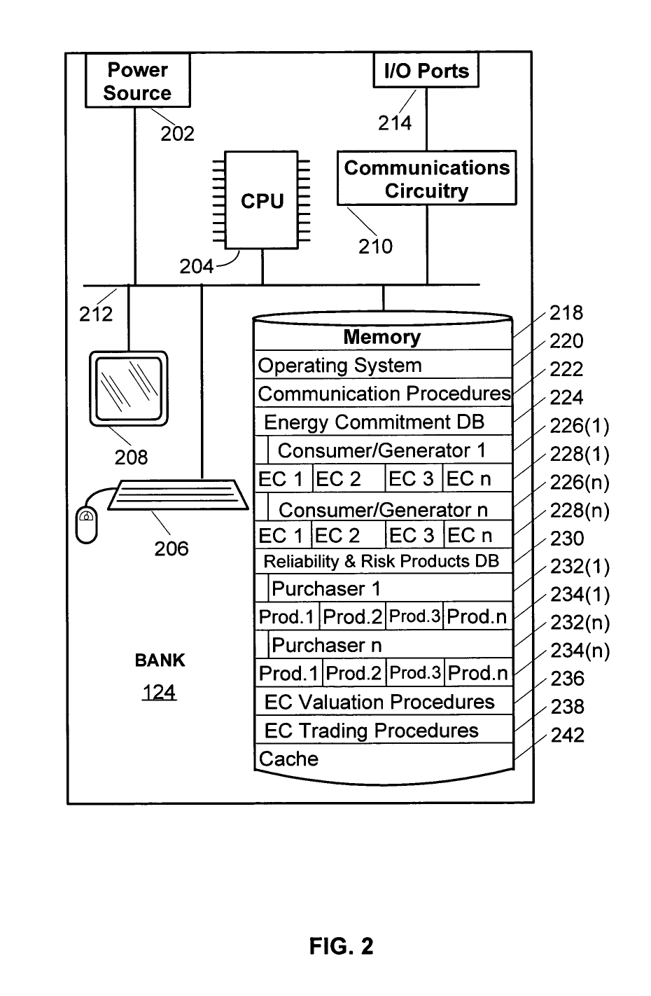

FIG. 2 is a block diagram of a preferred embodiment of the bank 124 shown in FIG. 1. Again, it should be appreciated that while FIG. 2 illustrates one embodiment of the present invention in terms of demand/supply response commitments, it is equally applicable to energy delivery commitments, wherein the energy consumers/generators would be instead an entity that delivers energy, such as a transmission/distribution company or a grid operator and references specifically to demand/supply response commitments would refer instead to energy delivery commitments.

The bank 124 is preferably a computer and includes: at least one data processor or central processing unit (CPU) 204; a memory 218; communications circuitry 210 for communicating with the energy consumers/generators 102-108, aggregator 110, third party appraiser 126 and energy market participants 114-122, as described in connection with FIG. 1; input and output (I/O) ports 214 coupled to the communication circuitry 210; a power source 202; and at least one bus 212 that interconnects these components. The computer may optionally include one or more user interface devices, such as a monitor 208 and a keyboard/mouse 206.

Memory 218 preferably includes high-speed random access memory and may include non-volatile memory, such as one or more magnetic disk storage devices. The memory 218 preferably stores an operating system 220, such as LINUX, UNIX, or WINDOWS, that includes procedures for handling basic system services and for performing hardware dependent tasks. The memory 218 also preferably stores communication procedures 222 used for communicating with the energy consumers/generators 102-108, aggregator 110, third party appraiser 126 and energy market participants 114-122, as described in connection with FIG. 1. In particular, the communication procedures 222 are used for: receiving energy commitments from the energy consumers/generators or aggregator(s); instructing third party appraisers to perform valuations of energy consumers'/generators' demand/supply resources or abilities to actually perform the commitment made; receiving valuations from the third party appraisers; receiving purchase requests from the energy market participant(s); and transmitting energy commitments to the energy market participant(s).

The memory 218 also preferably includes: an energy commitment database (DB) 224, a reliability and risk products database 230, energy commitment (EC) valuation procedures 236, energy commitment (EC) trading procedures 238, and a cache 242 for temporarily storing data. The energy commitment database 224 includes energy commitments (EC 1-n) 228(1)-(n), i.e., demand response commitments and supply response commitments for each energy consumer/generator (Consumer/Generator 1-n) 226(1)-(n) from whom the bank 124 has bought such commitments. Each energy commitment preferably includes: a energy commitment identifier; the amount of energy that an energy consumer agrees to forego or avoid using, such as “z” megawatt-hours; a period when the demand response can be exercised, for example, “x” times each summer season over the next “y” years, or the amount of energy that an energy generator agrees to generate, such as “z” megawatt-hours; a period when the energy commitment can be exercised, for example, “x” times each summer season over the next “y”; the consideration to be paid for the energy commitment, such as an initial payment or an ongoing payment or combination thereof; a viability rating for the energy commitment, which may be secured from a third party appraiser; etc.

The reliability and risk products database 230 preferably contains energy commitments or portions thereof that have been grouped or packaged together as single products (Prod. 1-n) 234(1)-(n). It should be appreciated that such products may be defined by the needs of the purchaser. Each product 234(1)-(n) preferably contains multiple energy commitments or portions thereof, the cost of each product 234, etc. It should be appreciated that each product may contain both demand and/or supply response commitments and/or portions thereof. For example, one product may include a number of demand response commitments for different geographic areas within a particular region, different periods for reduction of energy consumption, different amounts of energy required to be reduced, etc. Similarly, another product may include a number of supply response commitments for different geographic areas within a particular region, different periods for increased energy generation, different amounts of energy required to be generated, etc.

The energy commitment valuation procedures 236 are used for determining the viability of the energy commitments. Such a valuation may include a technical appraisal of the energy consumer's/generator's ability to comply with its commitment to reduce or generate energy upon demand, an evaluation of the energy market at the time of the purchase, etc. The energy commitment trading procedures 238 are used to trade the energy commitments on the open-market to any purchaser, such as the energy market participants 114-124 whenever requested.

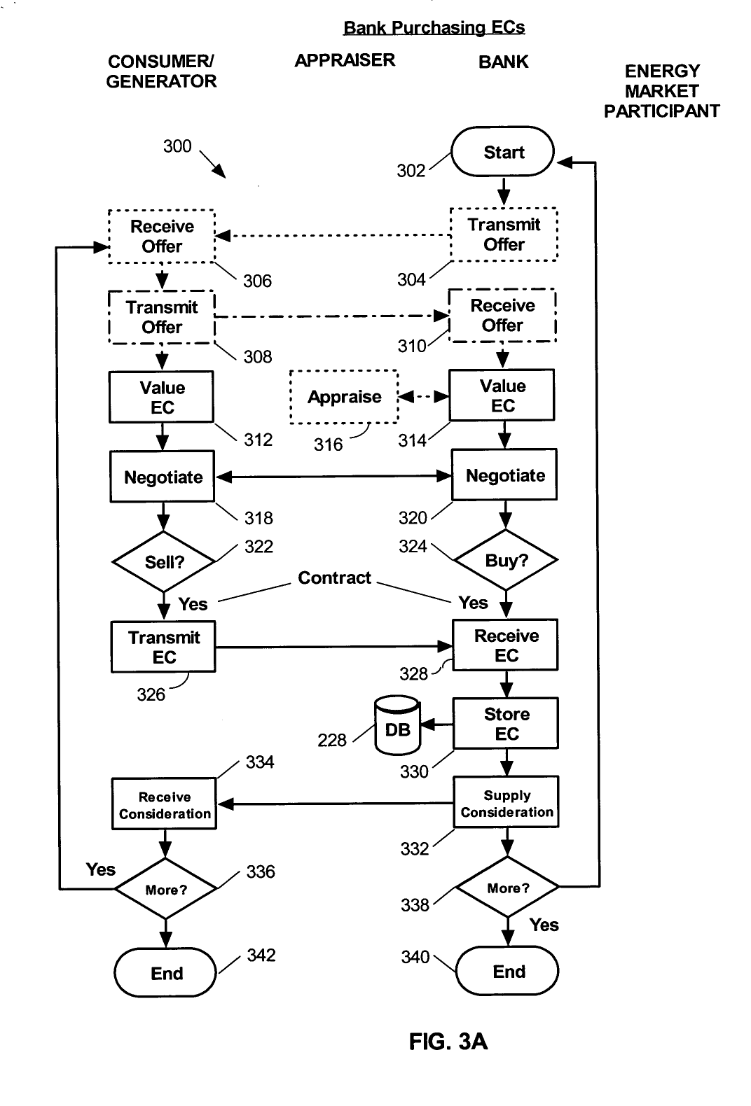

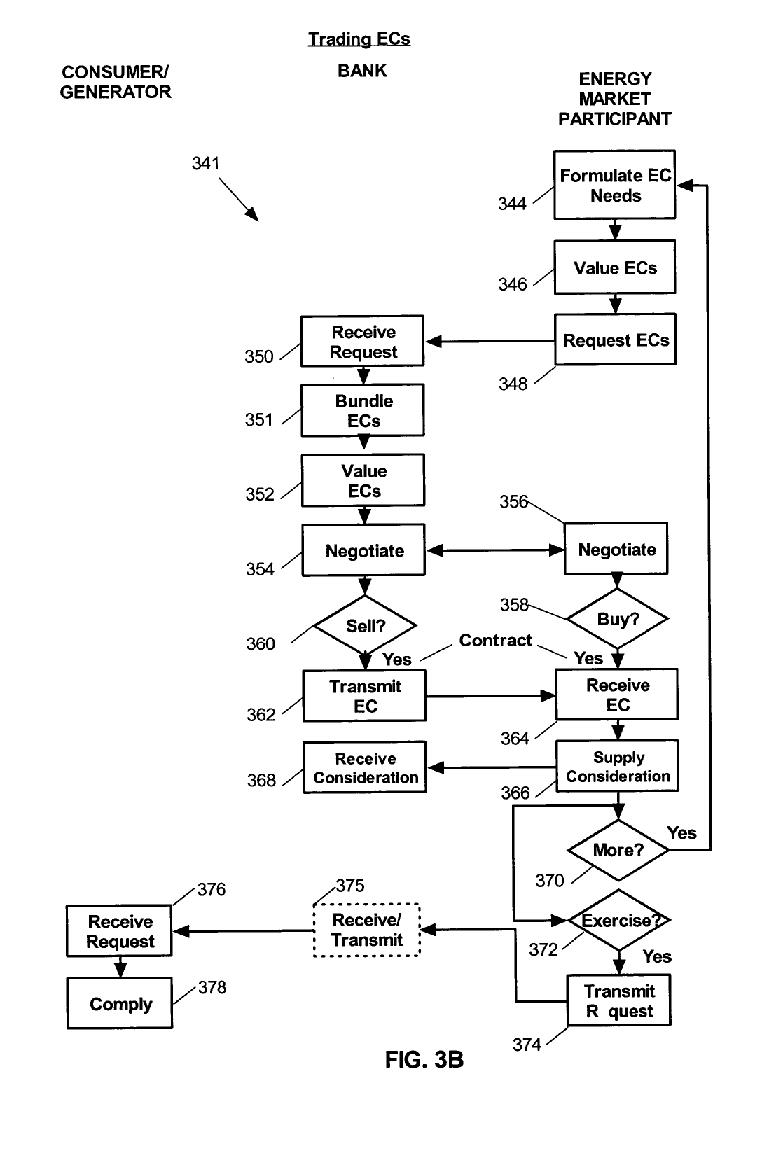

FIG. 3A is a flow chart of a method 300 for purchasing energy commitments. Again, it should be appreciated that while the following discussion of FIG. 3A is directed to one embodiment of the present invention in terms of demand/supply response commitments, it is equally applicable to energy delivery commitments, wherein the energy consumers/generators would be instead an entity that delivers energy, such as a transmission/distribution company or a grid operator and references specifically to demand/supply response commitments would refer instead to energy delivery commitments.

In one embodiment, the method 300 is initiated by the bank at step 302 by transmitting an offer to purchase an energy commitment from an energy consumer/generator at step 304. The offer is accepted by the consumer/generator at step 306. Alternatively, the energy consumer/generator may transmit an unsolicited offer to sell an energy commitment to the bank at step 308, in which case, the bank receives the offer to sell at step 310. In any event, it should be appreciated that the offer can be made by either the bank or the consumer/generator. In addition, the offer can be to buy or sell one or more energy commitments. Also, the offer may be made from or to an aggregator 110 (FIG. 1) instead of the consumer/generator.

The energy consumer/generator and bank then preferably independently value the energy commitment at 312 and 314, respectively. In a preferred embodiment, this is performed at the bank by the energy commitment valuation procedures 238 (FIG. 2). In addition, as described above, the bank may employ the services of the third party appraiser 126 to appraise the viability of the energy commitment, including the reliability of the energy consumer's/generator's ability to reduce energy demand upon request or generate energy, respectively, at step 316. The energy consumer/generator may value its energy commitment by any suitable means.

The energy consumer/generator and the bank then negotiate the consideration for the energy commitment at steps 318 and 320. Such negotiation may occur electronically, such as by using a reverse auction or other suitable price determination mechanism. Alternatively, the negotiations may occur in person, telephonically or the like. Once negotiations have completed, and the energy consumer/generator decides to sell the energy commitment (322—Yes) and the bank agrees to buy the energy commitment (324-Yes), then a contract is formed for the sale and purchase of the energy commitment.

Thereafter, the energy consumer/generator transmits the energy commitment to the bank at step 326 and the bank receives the energy commitment at step 328. In a preferred embodiment, once the terms of the contract have been negotiated, the finalized terms are presented to the energy consumer/generator and the bank, which both electronically sign the purchase agreement for the energy commitment.

The purchased energy commitment is then stored in the energy commitment database 228 (FIG. 2) by the bank at step 330. In this way, energy commitments purchased by the bank can be stored for later trading or resale to the energy market participants 114-122 (FIG. 1).

The bank then subsequently supplies the energy consumer/generator with consideration for the energy commitment at step 332. This consideration may take the form of a direct cash transfer, such as a one-time fixed payment or a fixed minimum payment that may or may not be coupled with a periodic additional payment or a loan, etc. This consideration is then received by the energy consumer/generator at step 334. The energy consumer/generator then determines whether any further energy commitments are to be sold at step 336. If further energy commitments are to be sold (336—Yes), the process repeats itself at step 306, otherwise the method 300 ends at step 342. Similarly, the bank then determines whether any further energy commitments are to be bought at step 338. If further energy commitments are to be sold (338—Yes), the process repeats itself at step 302, otherwise the method 300 ends at step 340.

FIG. 3B is a flow chart of a method 341 for trading energy commitments. Again, it should be appreciated that while the following discussion of FIG. 3B is directed to one embodiment of the present invention in terms of demand/supply response commitments, it is equally applicable to energy delivery commitments, wherein the energy consumers/generators would be instead an entity that delivers energy, such as a transmission/distribution company or a grid operator and references specifically to demand/supply response commitments would refer instead to energy delivery commitments.

Whenever a energy market participant desires to purchase one or more energy commitments, or portions thereof, the energy market participant formulates its energy commitment needs at step 344. Because of the varied interests of the energy market participants, formulation of the energy commitment needs at step 344 occurs at different times and for different reasons. For example, some energy market participants might only want the reliability-enhancement or near real-time resource benefits, while others might want capacity and energy cost avoidance benefits. Still other energy market participants might want to shift energy patterns from one part of the day to another.

Once the energy market participant has formulated its energy commitment needs, the energy market participant determines the value of the energy commitments or products that it wishes to purchase at step 346. For example, the energy market participant may determine that it would like demand response commitments for “x” megawatt-hours over the entire summer period from June through August. The energy market participant then values these demand response commitments based on current market conditions, etc. The energy market participant then requests these demand response commitments at step 348. The request for the demand response commitments is received by the bank at step 350, which is preferably made electronically over a secure connection.

The energy commitment trading procedures 238 (FIG. 2) in the bank's memory 218 then preferably automatically bundle one or more energy commitments stored in the energy commitment database 224 (FIG. 2) into a product that will satisfy the request from the energy market participants, at step 351. The energy commitment trading procedures 238 (FIG. 2) also preferably automatically value the product, at step 352, where the valuation is based on current market conditions, such as supply and demand.

Negotiations then occur between the bank and the energy market participant at steps 354 and 356, respectively. If both the bank agrees to sell (360—Yes), and the energy market participant agrees to buy (358—Yes), a contract is formed between the bank and the energy market participant. Thereafter, the bank transmits the energy commitment to the energy market participant at step 362. The energy market participant receives the energy commitment at step 364 and supplies consideration for the energy commitment to the bank at step 366. This consideration may take the form of a cash transfer, etc. The consideration is received by the bank at step 368.

The energy market participant then determines whether any further purchases need to occur. If further purchases need to occur (370—Yes), then the method repeats itself at step 344. At any time thereafter, the energy market participant may choose to exercise the energy commitment or demand performance under the commitment by the entity that made the commitment. For example, if the energy market participant that bought a demand response commitment actually requires a reduction in energy demand (372—Yes), then the energy market participant transmits a request to the energy consumer/generator at step 374 that made the commitment to actually perform what was committed to (e.g., to actually reduce or increase energy consumption or increase or reduce energy generation). It should be appreciated that the energy market participant may transmit the request to the bank at step 375, which would in turn transmit the request to the energy consumer/generator. It should be appreciated that if a product contains a portion of a particular energy consumer's/generator's energy commitment, then only that portion may be exercised by the purchaser of that product. Further, should additional products containing the remainder of that energy consumer's/generator's commitment be sold to other energy market participants, that energy consumer/generator would be required to comply with its commitment upon request from several different purchasers.

The request is received at step 376, and the energy consumer/generator then complies with the request at the step 378 by reducing or increasing energy demand or increasing or reducing energy generation in accordance with the demand or supply response commitment, respectively, or that portion now owned by the energy market participant, that the energy consumer/generator originally entered into with the bank.

Various embodiments of the invention have been described. The descriptions are intended to be illustrative of the present invention. It will be apparent to one of skill in the art that modifications may be made to the invention as described without departing from the scope of the claims set out below. For example, as discussed above, trading of energy commitments may also include energy delivery commitments, including commitment to deliver energy and commitments to not deliver energy. In addition, it should be appreciated that the methods described herein do not necessarily need to be performed in the specific sequence or steps as described.

Further, it should be appreciated that any entity may trade in such energy commitments. Although upon demand, performing such energy commitments (e.g., actually reducing or increase energy consumption, increasing or reducing energy generation, or actually delivering energy) would ultimately be done by energy consumers, generators and transmission/distribution companies, any entity may trade in such energy commitments, including all entities that deal in the general energy market.

It should also be appreciated that the methods of the present invention, including trading of commitments by a centralized entity or bank, may more generally be applicable to other industries or markets. For example, a centralized location or entity may be used to receive, hold and subsequently trade commitments to use or forego use of airline seats or commitments to use or forego use of particular fuels, such as barrels of oil or quantities or water. Basically, any industry or market in which a commitment to perform or forego an act, including the buying and selling of certain commodities or products, wherein such commitments are deposited or sold to a centralized entity that receives such commitments and holds them for immediate or later trading or sale may make use of the methods, apparatus and system of the present invention. The presently disclosed embodiments are, therefore, to be considered in all respects as illustrative and not restrictive, the scope of the invention being indicated by the appended claims, and not limited to the foregoing description.

1. A method for trading energy commitments to reduce or increase energy consumption, to increase or reduce energy generation, or to deliver energy, comprising:
receiving, solely for trading, a plurality of multi-year energy commitments;
providing consideration for each of said multi-year energy commitments; and
trading at least one of said plurality of energy commitments upon demand.

2. The method of claim 1, wherein said receiving comprises receiving a plurality of multi-year demand response commitments to reduce energy consumption upon demand.

3. The method of claim 1, wherein said receiving comprises receiving a plurality of multi-year supply response commitments to increase energy generation upon demand.

4. The method of claim 1, wherein at least one of said multi-year commitments comprises an obligation to reduce energy consumption or to increase energy generation by a predetermined amount during a predetermined season for each of a predetermined number of years.

5. The method of claim 1, wherein said consideration comprises a loan.

6. The method of claim 1, wherein said consideration comprises a fixed-minimum monetary payment.

7. The method of claim 6, wherein said consideration further comprises an additional payment based on market conditions.

8. The method of claim 1, further comprising, prior to said receiving, selecting said plurality of multi-year commitments to minimize a financial risk relative to said consideration.

9. The method of claim 8, wherein said plurality of multi-year energy commitments comprise energy commitments to reduce energy consumption or to increase energy generation during different seasons.

10. The method of claim 8, wherein said plurality of multi-year energy commitments comprise energy commitments to reduce energy consumption or to increase energy generation during a predetermined number of years.

11. The method of claim 8, wherein said plurality of multi-year energy commitments comprise energy commitments to reduce energy consumption or to increase energy generation during a predetermined number of overlapping seasons.

12. The method of claim 8, wherein said plurality of multi-year energy commitments comprise energy commitments to reduce energy consumption or to increase energy generation during a predetermined number of overlapping years.

13. The method of claim 8, wherein said plurality of multi-year energy commitments comprise energy commitments to reduce energy consumption or to increase energy generation in geographically different areas.

14. The method of claim 8, wherein said plurality of multi-year energy commitments comprise energy commitments to reduce energy consumption from different energy consumers or to increase energy generation from different energy generators.

15. The method of claim 8, wherein said plurality of multi-year energy commitments comprise energy commitments to reduce energy consumption by different amounts or to increase energy generation by different amounts.

16. The method of claim 1, further comprising evaluating the viability of each of said multi-year energy commitments.

17. The method of claim 16, wherein said evaluating comprises determining the technical reliability of each of said multi-year energy commitments.

18. The method of claim 16, wherein said evaluating comprises determining the economic feasibility of each of said multi-year energy commitments.

19. The method of claim 1, further comprising combining, prior to said trading, at least two of said multi-year energy commitments into a product, wherein said trading comprises trading said product.

20. The method of claim 1, wherein said receiving comprises receiving at least one of said multi-year energy commitments from an aggregator of said multi-year commitments.

21. A method for trading energy commitments to reduce or increase energy consumption, to increase or reduce energy generation, or to deliver energy, comprising:
receiving a plurality of multi-year energy commitments to reduce or increase energy consumption, to increase or reduce energy generation, or to delivery energy by a predetermined quantity upon demand;
providing consideration for each of said multi-year energy commitments;
combining at least a portion of at least two of said multi-year energy commitments to form a product;
trading said product upon request.

22. A method for trading energy commitments to reduce or increase energy consumption or to increase or reduce energy generation, comprising:
receiving a plurality of unsolicited offers for multi-year energy commitments to reduce or increase energy consumption, to increase or reduce energy generation, or to deliver energy by a predetermined quantity upon demand;
accepting said plurality of unsolicited offers;
providing consideration for each of said multi-year energy commitments;
combining at least a portion of at least two of said multi-year energy commitments to form a product;
trading said product upon request.

23. The method of claim 22, wherein said receiving comprises receiving a plurality of multi-year demand response commitments from separate energy consumers, wherein said energy consumers do not have energy generation capabilities.

24. A system for trading energy commitments to reduce or increase energy consumption, to increase or reduce energy generation, or to deliver energy comprising:
a bank having:
a processor;
communications circuitry for communicating with one or more energy consumers, energy generators, aggregators, third party appraisers, or energy market participants; and
a memory, comprising:
an operating system;
communication procedures for receiving, solely for trading, a plurality of multi-year energy commitments, and providing consideration for each of said multi-year energy commitments; and
energy commitment trading procedures for trading at least one of said plurality of energy commitments upon demand.

25. A computer program product for trading energy commitments to reduce or increase energy consumption, to increase or reduce energy generation, or to deliver energy, the computer program product comprising a computer readable storage and a computer program stored therein, the computer program comprising:
instructions for receiving, solely for trading, a plurality of multi-year energy commitments;
instructions for providing consideration for each of said multi-year energy commitments; and
instructions for trading at least one of said plurality of energy commitments upon demand.
